(19) United States
(12) Patent Application Publication
(10) Pub. No.: US 2002/0089415 A1
(43) Pub. Date: Jul. 11, 2002

(54) Lighted antenna ornaments

(76) Inventor: Vernon R. Bell, Caldwell, ID (US)

Correspondence Address: PEDERSEN & COMPANY, PLLC, P.O. BOX 2666, BOISE, ID, 83701, US

(21) Appl. No.: 10/001,228

(22) Filed: Oct. 25, 2001

Related U.S. Application Data
(60) Provisional application No. 60/243,627, filed on Oct. 25, 2000.

(51) Int. Cl. G08B 5/00

(52) U.S. Cl. 340/332; 340/331

(57) ABSTRACT

The present invention is a lighted vehicle antenna ornament. Preferably, the lighted ornament is made of Styrofoam or other equivalent material. The Styrofoam piece may be of any convenient size or shape, as long as it is easily and securely mountable on a vehicle antenna. Preferably, the lighted antenna ornament is lit with ordinary tiny Christmas tree lights. The lights may be of any convenient size or shape, or any color. Also, the lights may be constant-on, flashing, or operate in a sequence. In a preferred embodiment the electrical leads may extend from the bottom of the antenna, through the vehicle door seam near the hinges, and into the front passenger part of the interior, where they are connected to power in the dashboard via a cigarette adaptor.

This application claims priority from prior pending provisional application Serial No. 60/243,627 filed on Oct. 25, 2000 with the same title.

### BACKGROUND OF THE INVENTION

1. Field of the Invention

This invention relates generally to vehicle ornamentation, and more specifically to lighted antenna ornaments for vehicles.

2. Related Art

Many vehicle owners place ornaments on their vehicle antennas. One popular group of these antenna ornaments are Styrofoam ornaments of different shapes. The Styrofoam ornaments may be spheres, or balls, or other shapes, like coffee cups. Usually, the Styrofoam piece has a recess in it for receiving the vehicle antenna. This way, when the Styrofoam ornament is mounted on the antenna, it is well visible. Other materials structurally equivalent to Styrofoam for this use may also be used.

U.S. Pat. No. 5,933,081 (Jones) discloses a lighted antenna ornament adapted to be fitted around and extend up the sides of a vehicle antenna. The Jones device is not secured to the top of the antenna. Also, the lighted portion of the Jones device is near the bottom of the antenna.

Also, WALLY BALLS of Studio City, Calif., USA sells a line of whimsical ornaments for the top of vehicle antennas. These ornaments, however, are not lighted.

### SUMMARY OF THE INVENTION

The present invention is a lighted vehicle antenna ornament. Preferably, the lighted ornament is made of Styrofoam or other equivalent material. The Styrofoam piece may be of any convenient size or shape, as long as it is easily and securely mountable on a vehicle antenna. Preferably, the lighted ornament is adapted to receive, and be secured to the top of the antenna.

Preferably, the lighted antenna ornament is lit with ordinary tiny Christmas tree lights. The lights may be of any convenient size or shape, or any color. Also, the lights may be constant-on, flashing, or operate in a sequence.

Preferably, the lights for the Styrofoam piece are mounted so that a visible portion of them extends out from the surface of the piece. Preferably, the connecting electrical leads run from the back of the lights through the Styrofoam piece, and into a recess near the center of the Styrofoam piece for receiving the antenna. There, the electrical leads extend out from the Styrofoam piece where they are connected to electrical power. For example, the electrical leads may be in a wire which wraps around or extends down the antenna, and extends further into the vehicle. For example, in a preferred embodiment the electrical leads may extend from the bottom of the antenna, through the vehicle door seam near the hinges, and into the front passenger part of the interior, where they are connected to power in the dashboard via a conventional cigarette lighter adaptor.

### BRIEF DESCRIPTION OF THE DRAWINGS

FIG. 1 is a schematic, side cross-sectional view of one embodiment of the invention, with an antenna ball shown in dashed lines.

FIGS. 2A-2J are side perspective views of several, but not all, alternative external ornamental design embodiments of the invention.

### DETAILED DESCRIPTION OF THE INVENTION

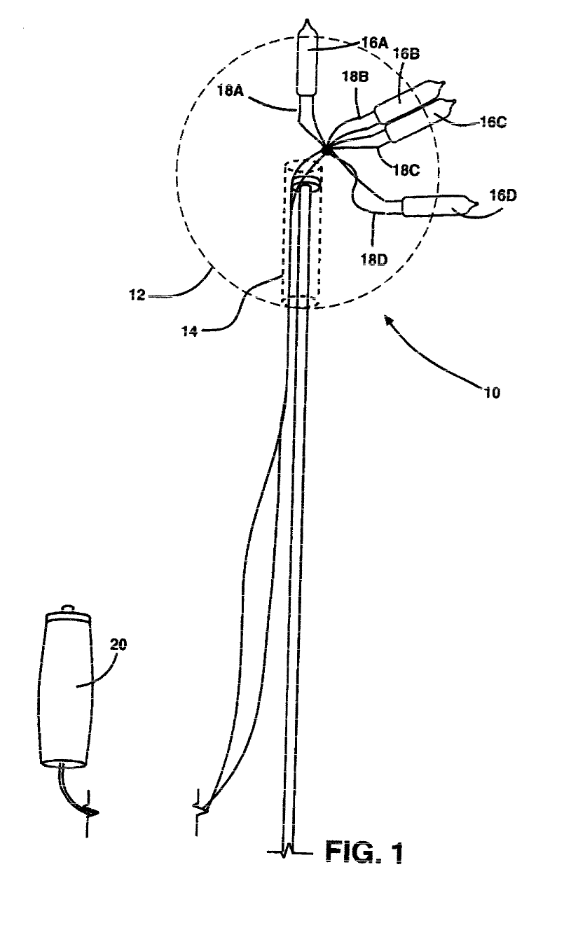

Referring to the Figures, there are depicted several, but not all, embodiments of the present invention. In FIG. 1, there is depicted a schematic, side cross-sectional view of one embodiment 10 of the invention. Lighted antenna ornament 10 has ball 12 of Styrofoam, with the ball shown in dashed lines. Styrofoam ball 12 has generally central bottom recess 14 for receiving the top of an antenna of a vehicle. Mounted in ball 12 are lights 16A-16D. Preferably, these lights each have a distal portion which extends out from the surface of ball 12, for example to serve as eyes, nose, ears, etc. Also, each of these lights has a proximal portion from which an electrical lead 18A-18D extends. Preferably, these electrical leads extend from the distal portion of lights 16A-16D into the top of recess 14 and out from the bottom of ball 12. There, electrical leads 18A-18D extend to a power source, for example, to conventional cigarette lighter adaptor 20.

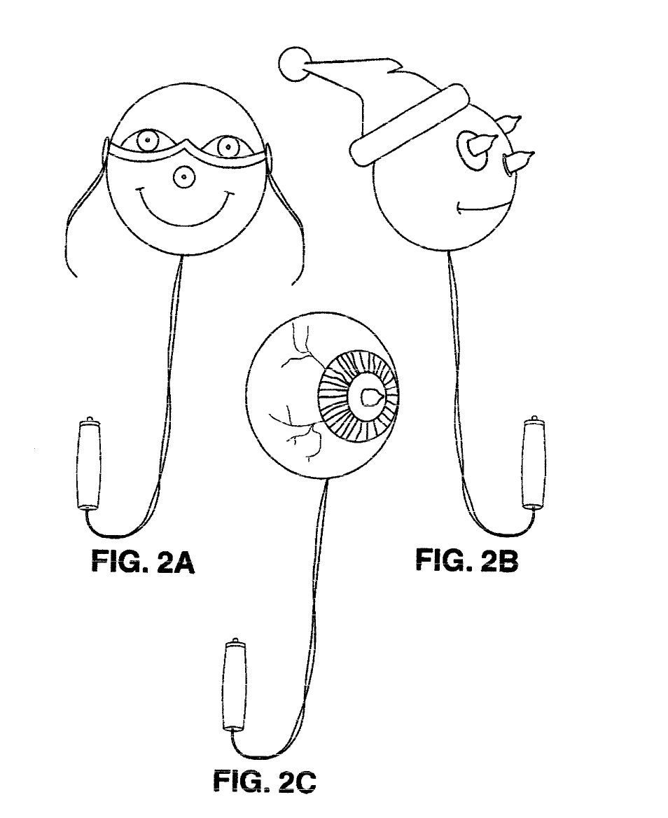

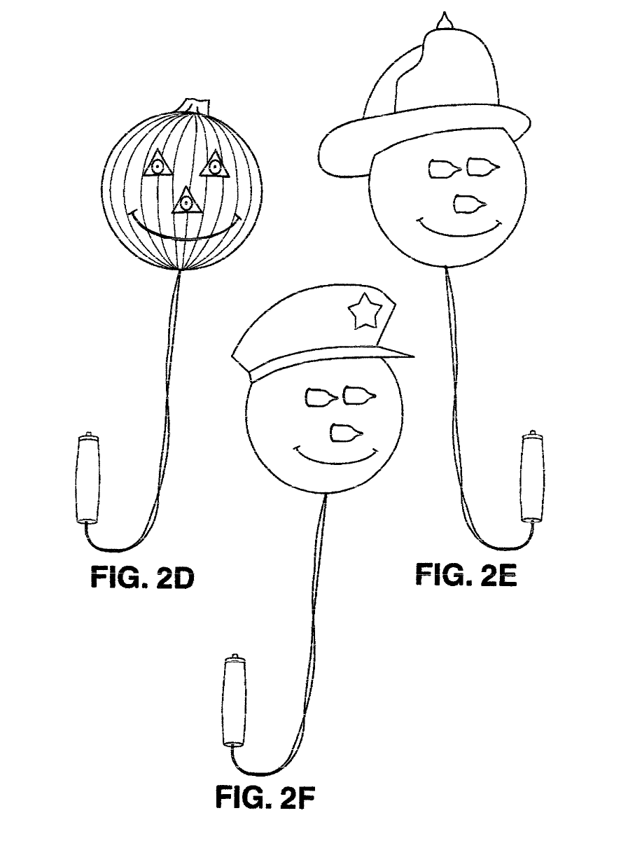

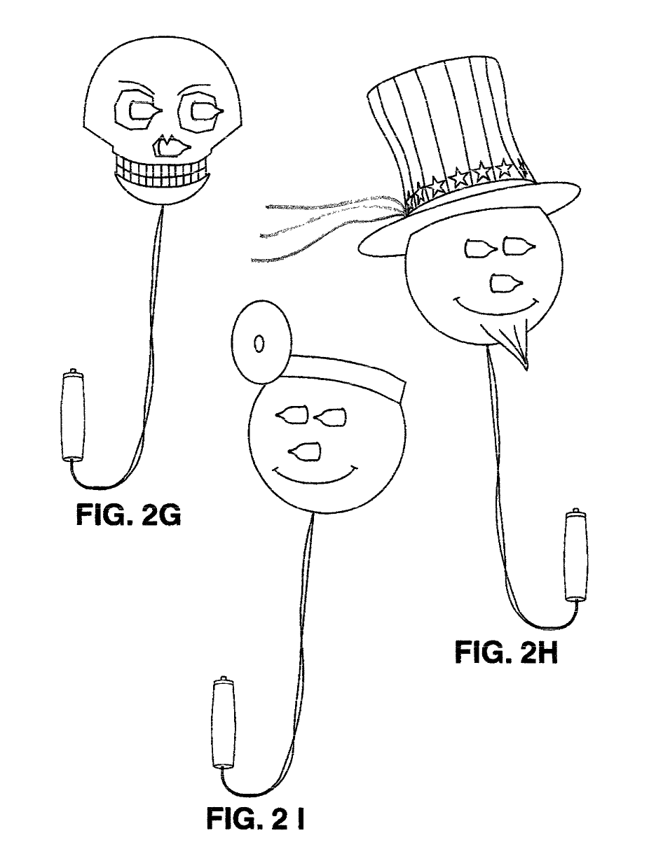

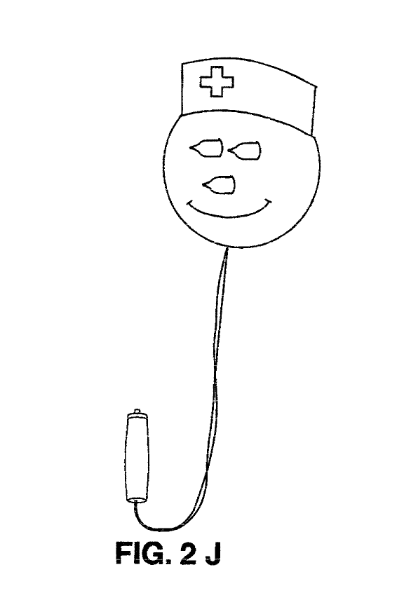

In FIG. 2, there are depicted side perspective views of several, but not all, alternative embodiments of external ornamental designs of the invention. While the preferred embodiments shown generally comprise spherical shapes, the main body of the ornament may be other than spherical, and may have many arrangements of lights in or on it. The main body of the ornament may have discreet lights extending from it or visible from it, as in the Figures, or, the main body may be translucent or transparent and the light/lights may emit light through the main body rather than the lights protruding from the main body. That is, the main body surface in its entirely may glow or shine, or portions of it may glow or shine in a pattern or design. The lighted antenna ornament of the invention may be presented as different, well-known types of faces, with additional ornamentation on the ball or other shape, for example. Also, other, well-known lighted images such as signs, symbols and logos may also be presented.

Also, many different types of lights may be used, as long as they are of the low-heat type so they don't melt or burn the Styrofoam or other ornament body material. LCD, LED, and other modern lights are contemplated. Preferably, the lights are secured into holes drilled into the ornament body material and lined with adhesive. However, simple friction or adhesive connections only may also suffice. In addition, an adhesive may be provided in recess 14 to more securely affix the ornament to the top of the antenna.

The power source discussed above may be any convenient, effective source. For example, electrical leads 18A-18D may extend to a battery, solar cell, or the vehicle's electrical system. Also, any convenient electrical control circuit, switching, timer, or logic circuit may be used for the lights, for special effects, timing of operation, or sequence. For example, constant-on, flashing, or sequence operation of the lights may be done. Also, for example, a photosensitive cell may operate to automatically turn the lights on in low light conditions. There may be one of, or a plurality of, the lights themselves. Thus, even when the vehicle is off, for example, parked in a parking lot, the lighted ornament may be illuminated, for an attractive, whimsical, or other effect. For example, a user may enjoy the lighted ball as a way to indicate where his/her vehicle is parked.

Also, the ball 12 may be a clear plastic ball or other shape, and lights 16A-16D mounted inside the ball for an illuminated or glowing effect. In this case, for example, a film-like decal, paint, or other coloration may be mounted on the ball outer surface to help impart an image to the ball.

Although this invention has been described with reference to particular means, materials and embodiments, it is to be understood that the invention is not limited to these disclosed particulars, but extends instead to all equivalents within the broad scope of this description and the following claims.

What we claim is:

1. A lighted antenna ornament, comprising:
an ornament body with a generally central recess at its bottom end for receiving and being secured to the top of an antenna; and
an electrical light secured to said ornament body.

2. The antenna ornament of claim 1 wherein the light has an electrical lead which extends from said light to said central recess.

3. The antenna ornament of claim 1 which has a plurality of lights.

4. The antenna ornament of claim 2 wherein said electrical lead extends into said central recess and out from said ornament body to an external power source.
